(19) United States
(12) Patent Application Publication
(10) Pub. No.: US 2026/0343581 A1
(43) Pub. Date: Oct. 29, 2026

(54) METHOD TO RESOLVE IMD GENERATED IN-DEVICE COEXISTENCE ISSUE

(71) Applicant: Nokia Technologies Oy, Espoo (FI)

(72) Inventors: Poul OLESEN, Aalborg (DK); Benoist Pierre SEBIRE, Tokyo (JP); Jarkko Tuomo KOSKELA, Oulu (FI); Faranaz SABOURI-SICHANI, Aalborg (DK)

(21) Appl. No.: 19/102,576

(22) PCT Filed: Aug. 18, 2023
(86) PCT No.: PCT/IB2023/058289

§ 371 Date: Feb. 10, 2025

Related U.S. Application Data
(60) Provisional application No. 63/399,369, filed on Aug. 19, 2022.

(51) Int. Cl. H04W 72/541; H04W 72/0453; H04W 72/0457; H04W 72/231

(52) U.S. Cl. CPC H04W 72/541; H04W 72/0453; H04W 72/0457; H04W 72/231

(57) ABSTRACT

An apparatus may be configured to: detect in-band interference; determine that intermodulation distortion caused the detected in-band interference; determine at least one interfered frequency affected by the intermodulation distortion; and transmit, to a network, an indication of the at least one interfered frequency affected by the intermodulation distortion. An apparatus may be configured to: configure a user equipment to provide an indication of at least one interfered frequency affected by intermodulation distortion; receive, from the user equipment, the indication of the at least one interfered frequency affected by the intermodulation distortion; determine a decision as to whether a network triggered solution would resolve the intermodulation distortion for the user equipment; and transmit, to the user equipment, a message based, at least partially, on the decision.

### TECHNICAL FIELD

The example and non-limiting embodiments relate generally to radio frequency interference and, more particularly, to in-device coexistence issue(s).

### BACKGROUND

It is known, in radio frequency performance enhancement, to measure and detect in-band unwanted signals along with the desired received signals.

### SUMMARY

The following summary is merely intended to be illustrative. The summary is not intended to limit the scope of the claims.

In accordance with one aspect, an apparatus comprising: at least one processor; and at least one memory storing instructions that, when executed by the at least one processor, cause the apparatus at least to: detect in-band interference; determine that intermodulation distortion caused the detected in-band interference; determine at least one interfered frequency affected by the intermodulation distortion; and transmit, to a network, an indication of the at least one interfered frequency affected by the intermodulation distortion.

In accordance with one aspect, a method comprising: detecting, with a user equipment, in-band interference; determining that intermodulation distortion caused the detected in-band interference; determining at least one interfered frequency affected by the intermodulation distortion; and transmitting, to a network, an indication of the at least one interfered frequency affected by the intermodulation distortion.

In accordance with one aspect, an apparatus comprising means for performing: detecting in-band interference; determining that intermodulation distortion caused the detected in-band interference; determining at least one interfered frequency affected by the intermodulation distortion; and transmitting, to a network, an indication of the at least one interfered frequency affected by the intermodulation distortion.

In accordance with one aspect, a non-transitory computer-readable medium comprising program instructions stored thereon for performing at least the following: causing detecting of in-band interference; determining that intermodulation distortion caused the detected in-band interference; determining at least one interfered frequency affected by the intermodulation distortion; and causing transmitting, to a network, of an indication of the at least one interfered frequency affected by the intermodulation distortion.

In accordance with one aspect, an apparatus comprising: at least one processor; and at least one memory storing instructions that, when executed by the at least one processor, cause the apparatus at least to: configure a user equipment to provide an indication of at least one interfered frequency affected by intermodulation distortion; receive, from the user equipment, the indication of the at least one interfered frequency affected by the intermodulation distortion; determine a decision as to whether a network triggered solution would resolve the intermodulation distortion for the user equipment; and transmit, to the user equipment, a message based, at least partially, on the decision.

In accordance with one aspect, a method comprising: configuring, with a network, a user equipment to provide an indication of at least one interfered frequency affected by intermodulation distortion; receiving, from the user equipment, the indication of the at least one interfered frequency affected by the intermodulation distortion; determining a decision as to whether a network triggered solution would resolve the intermodulation distortion for the user equipment; and transmitting, to the user equipment, a message based, at least partially, on the decision.

In accordance with one aspect, an apparatus comprising means for performing: configuring a user equipment to provide an indication of at least one interfered frequency affected by intermodulation distortion; receiving, from the user equipment, the indication of the at least one interfered frequency affected by the intermodulation distortion; determining a decision as to whether a network triggered solution would resolve the intermodulation distortion for the user equipment; and transmitting, to the user equipment, a message based, at least partially, on the decision.

In accordance with one aspect, a non-transitory computer-readable medium comprising program instructions stored thereon for performing at least the following: causing configuration of a user equipment to provide an indication of at least one interfered frequency affected by intermodulation distortion; causing receiving, from the user equipment, of the indication of the at least one interfered frequency affected by the intermodulation distortion; determining a decision as to whether a network triggered solution would resolve the intermodulation distortion for the user equipment; and causing transmitting, to the user equipment, of a message based, at least partially, on the decision.

According to some aspects, there is provided the subject matter of the independent claims. Some further aspects are defined in the dependent claims.

### BRIEF DESCRIPTION OF THE DRAWINGS

The foregoing aspects and other features are explained in the following description, taken in connection with the accompanying drawings, wherein:

FIG. 1 is a block diagram of one possible and non-limiting example system in which the example embodiments may be practiced;

FIG. 2 is a diagram illustrating features as described herein;

FIG. 3 is a diagram illustrating features as described herein;

FIG. 4 is a flowchart illustrating steps as described herein;

FIG. 5 is a flowchart illustrating steps as described herein;

FIG. 6 is a diagram illustrating features as described herein;

FIG. 7 is a diagram illustrating features as described herein;

FIG. 8 is a diagram illustrating features as described herein;

FIG. 9 is a diagram illustrating features as described herein;

FIG. 10 is a flowchart illustrating steps as described herein; and

FIG. 11 is a flowchart illustrating steps as described herein.

### DETAILED DESCRIPTION OF EMBODIMENTS

The following abbreviations that may be found in the specification and/or the drawing figures are defined as follows:
3GPP third generation partnership project
5G fifth generation
5GC 5G core network
ACLR adjacent channel leakage ratio
AMF access and mobility management function
CA carrier aggregation
CRAN cloud radio access network
CU central unit
dB decibel
dBm decibel-milliwatt
DU distributed unit
eNB (or eNodeB) evolved Node B (e.g., an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, i.e., the LTE radio access technology
gNB (or gNodeB) base station for 5G/NR, i.e., a node providing NR user plane and control plane protocol terminations towards the UE, and connected via the NG interface to the 5GC
HW hardware
IDC in-device coexistence
I/F interface
IF intermediate frequency
IIP3 3^{rd} order input intercept point
IMD intermodulation distortion
ISM band Industrial, Scientific and Medical band
L1 layer 1
LNA low noise amplifier
LTE long term evolution
MAC medium access control
MME mobility management entity
NF noise figure
ng or NG new generation
ng-eNB or NG-eNB new generation eNB
NR new radio
N/W or NW network
OIP3 3^{rd} order output intercept point
OoB out-of-band
O-RAN open radio access network
PDCP packet data convergence protocol
PHY physical layer
RAN radio access network
RF radio frequency
RLC radio link control
RRC radio resource control
RRH remote radio head
RS reference signal
RSRP reference signal received power
RSRQ reference signal received quality
RSSI received signal strength indicator
RU radio unit
Rx receiver
SDAP service data adaptation protocol
SGW serving gateway
SIC self interference cancellation
SINR signal to interference plus noise ratio
SMF session management function
Tx transmitter
UE user equipment (e.g., a wireless, typically mobile device)
UPF user plane function
VNR virtualized network function

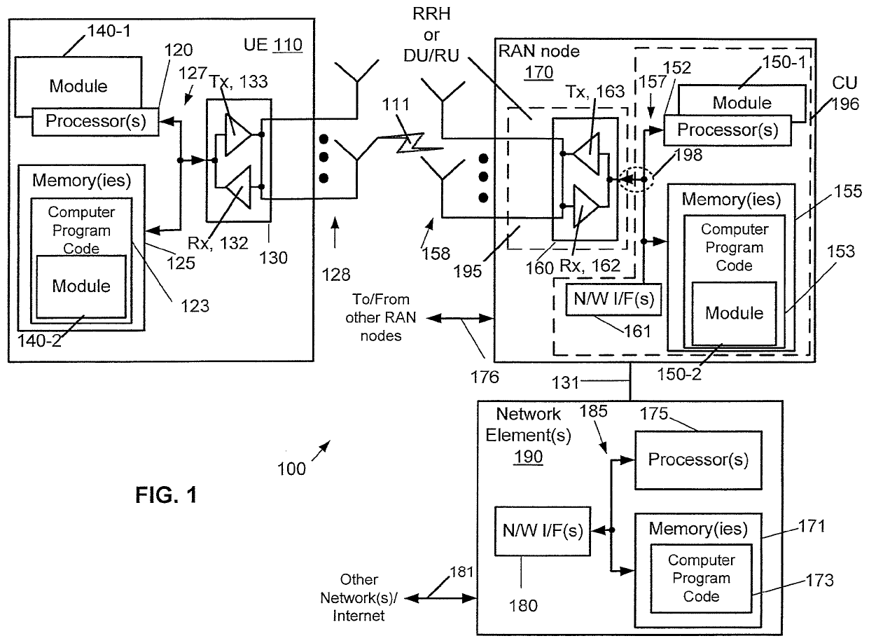

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. A “circuit” may include dedicated hardware or hardware in association with software executable thereon. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access by wireless devices such as the UE 110 to the wireless network 100. The RAN node 170 may be, for example, a base station for 5G, also called New Radio (NR). In 5G, the RAN node 170 may be a NG-RAN node, which is defined as either a gNB or a ng-eNB. A gNB is a node providing NR user plane and control plane protocol terminations towards the UE, and connected via the NG interface to a 5GC (such as, for example, the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station, access point, access node, or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, for example, fiber optic cable or other suitable network connection to connect the other elements (e.g., a central unit (CU), gNB-CU) of the RAN node 170 to the RRH/DU 195. Reference 198 also indicates those suitable network link(s).

It is noted that description herein indicates that “cells” perform functions, but it should be clear that equipment which forms the cell will perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include access and mobility management function(s) (AMF(s)) and/or user plane functions (UPF(s)) and/or session management function(s) (SMF(s)). Such core network functionality for LTE may include MME (Mobility Management Entity)/SGW (Serving Gateway) functionality. These are merely illustrative functions that may be supported by the network element(s) 190, and note that both 5G and LTE functions might be supported. The RAN node 170 is coupled via a link 131 to a network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. For example, a network may be deployed in a tele cloud, with virtualized network functions (VNF) running on, for example, data center servers. For example, network core functions and/or radio access network(s) (e.g. CloudRAN, O-RAN, edge cloud) may be virtualized. Note that the virtualized entities that result from the network virtualization are still implemented, at some level, using hardware such as processors 152 or 175 and memories 155 and 171, and also such virtualized entities create technical effects.

It may also be noted that operations of example embodiments of the present disclosure may be carried out by a plurality of cooperating devices (e.g. cRAN).

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Having thus introduced one suitable but non-limiting technical context for the practice of the example embodiments of the present disclosure, example embodiments will now be described with greater specificity.

Features as described herein generally relate to detection and correction of receiver interference. A UE's radio frequency (RF) performance, related to its robustness to interference (e.g. generated due to intermodulation), is according to 3GPP tested with unwanted signal levels of −46 dBm, while the wanted signal for some bands is set to about −91 dBm. Legacy devices can therefore not be expected to function properly if adjacent signal power is above −46 dBm within a few dB. Other 3GPP requirements seem to imply that linearity can be expected in case a signal level of −25 dBm is present at the receiver; however, if the nature of such a signal can cause 3rd order intermodulation products, the expected de-sense may be high, for example more than 60 dB.

In the present disclosure, the terms “wanted signal,” “wanted received signal”, “used channel”, “wanted frequency spectrum”, “desired spectrum”, “desired frequency”, and “wanted band” are used to refer to the frequency bands, and/or time and/or frequency resources, that a UE is configured to use for reception. These terms may be used interchangeably in the present disclosure.

In the present disclosure, the terms “unwanted signal”, “adjacent signal”, “aggressor signal”, “adjacent spectrum”, “adjacent frequency”, “interfering frequency”, “out-of-band spectrum”, and “aggressor” are used to refer to signals, frequency bands, and/or time and/or frequency resources, outside the wanted signal frequency spectrum that have an effect on the reception of the UE. These terms may be used interchangeably in the present disclosure.

In the present disclosure, the terms “interference”, “noise”, and “distortion” are used to refer to the effect of unwanted signals on the wanted signals. These terms may be used interchangeably in the present disclosure.

In the present disclosure, the term “in-band signal” may refer to any signal that is within the wanted received signal frequency bands, including the wanted signal(s) as well as interference and/or noise (which may be received at the antenna or generated as intermodulation product).

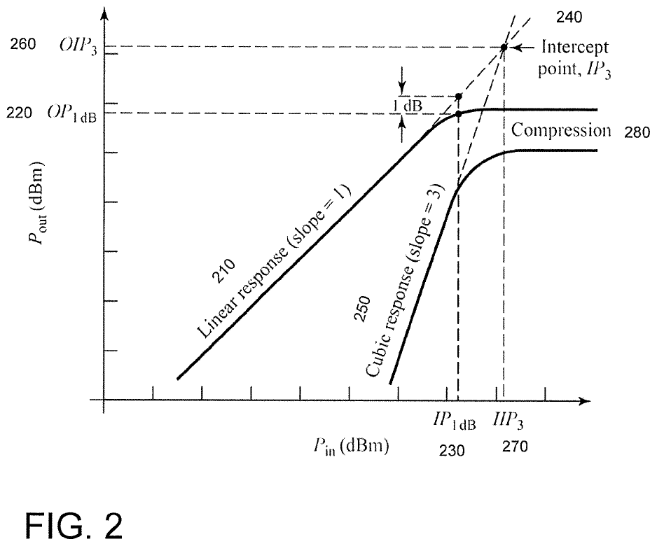

RF components like mixers and amplifiers do typically have a much higher 3rd order input intercept point (IIP3) than compression point. This is reflected in the 3GPP test cases: the maximum wanted input level is around −25 dBm for testing the UE's receiver linearity test, and the unwanted signal level during intermodulation test is −46 dBm, while the input level is quite low in one case: −91 dBm. Referring now to FIG. 2, illustrated is an example of IIP3 and a 1 dB compression point.

The linear response (210) may increase with a slope of 1 until approximately IP_{1dB} (230) and OP_{dB} (220). The cubic response (250) may increase with a slope of 3 until approximately IIP₃ (270) and OIP₃. The slopes of the linear response (210) and the cubic response (250) may meet at the intercept point, IP₃ (240). The compression (280) between the linear response (210) and the cubic response (250) may occur between IP_{1dB} (230) and IIP₃ (270), and may be a compression of 1 dB.

Compromises in the RF front end hardware design between parameters like linearity, gain, noise figure, and power consumption result in the fact that these requirements may only be obtained with a relatively small margin.

The baseband receive circuitry of a UE only measures and detects in-band signals. For this reason, it is not possible to determine if received in-band noise and distortion is caused by: high order intermodulation products due to strong RF signals in adjacent spectrum; in-band noise from co-channel and/or adjacent systems; and/or Adjacent Channel Leakage Ratio (ACLR) contributions from transmitters using adjacent spectrum. Linear reception may not be possible in such cases, and baseband circuitry and RF drivers may not be able to determine if the RF front end circuitry is driven in compression causing gain and noise figure compression, or if the problem is caused by strong RF signals in adjacent spectrum that cause intermodulation distortion (IMD) products that fold directly into the wanted band.

In-device Coexistence (IDC) requirements imply that we need to deal with interference between −10 dBm and +10 dBm, assuming 15 to 25 dB antenna isolation, which in turn implies that IMD products caused by such strong interference can cause more than 80 dB de-sense (i.e. reduced sensitivity of an antenna/receiver due to noise, intermodulation products, gain compression or noise figure compression). There are no obvious means to determine if such noise or distortion is caused by in-band noise only, or because of intermodulation products caused by strong RF power in adjacent spectrum.

Analogue tuning and RF isolation means may be used to deal with RF isolation; however, an intelligent metric to tune towards does not yet exist. Tuning adaptable antenna systems or analogue tunable self-interference cancellation (SIC) HW requires accurate knowledge about the root cause of the interference that causes the problem.

In an example embodiment, changes in HW may be implemented/configured. A technical effect of example embodiments of the present disclosure may be to allow distinguishing the noise generated in the receiver itself from out-of-band (OoB) aggressors, which may generate undesired signals in the receive band as the result of an intermodulation product.

A wide band receiver with high linearity may be implemented and used in parallel with the normal receiver by adding an attenuator or an RF coupler in front of a normal receive chain. Only signals above about −50 dBm (e.g. IMD-threshold) need to be detected, since the intermodulation requirements [3GPP TS 38.101-1 V17.6.0 (2022-06)] is measured with interfering signals with a power level of −46 dBm, and sufficient suppression should naturally occur for potential aggressor signals causing intermodulation which are below about −46 dBm. 30 to 40 dB attenuation may therefore be easily added in the hardware and switched in somehow, since only signals above −46 dBm need to be detected. A relatively high noise figure can therefore be tolerated for such an auxiliary receive path. This may be implemented as an auxiliary RF path connected to a coupler placed directly at the antenna port. An RF coupler may be connected directly at the antenna port, or at the LNA input. The same antenna may be connected to the two receivers, as a spatial tuning means may be used to suppress IMD generated interference.

This may have the technical effect of enabling the system to distinguish exactly between co-channel noise generated in the LNA itself, and noise from other systems or adjacent channel noise from a nearby aggressor. The out-of-band spectrum causing the noise may, in this way, be measured at the same time as signals detected or measured inside the channel. In this way, the root cause of the co-channel interference may be determined, which in turn may enable the system to select the best and/or optimum means to suppress it. Intermodulation may be tested with a wanted signal level 6 to 9 dB above the REFSENSE requirement; therefore, potential strong IMD interferers may be measured below −46 dBm (IMD-threshold), in case good intermodulation performance is desired close to the typical sensitivity threshold.

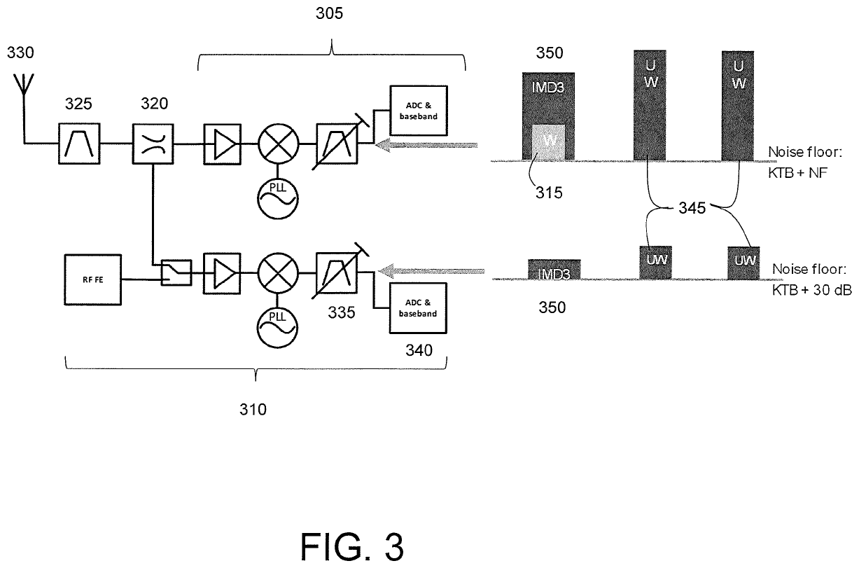

Referring now to FIG. 3, illustrated is a non-limiting example of wideband linear auxiliary receive circuitry (310) connected with a normal receive chain (305) that may be used in parallel. The wanted signal W (315) may not be detectable by the baseband if it is overlayed by noise and interference. The two receivers (305, 310) may be turned on simultaneously or sequentially, depending on the exact HW implementation means and system requirements. The reference signal received signal power level (RSRP) and signal quality (RSRQ) may be determined at the wanted/determined channel by measurement on reference signals. In addition, the received signal strength indicator (RSSI) may be measured as a total received signal level corresponding to all signals in the desired spectrum, including the effect of adjacent frequencies detected in the spectrum that can cause intermodulation by use of a linear receiver (e.g. 345, 350).

A table may be formed and continuously updated with the following content: RSRP, RSRQ, and/or RSSI for the wanted channel and interfering levels and frequencies, all as functions of spatial setting or any other cancellation setting(s), adaptable filter, filter bank, and/or other linearization means.

In the schematic diagram of FIG. 3, the wide band linear auxiliary receiver circuit (310) is shown together with the normal receiver (305). A coupler (320) may be located as shown, or between the filter (325) and the antenna (330). Coupling loss of 20 to 30 dB may be tolerable, as indicated above, since the noise figure (NF) may not be critical. An additional coupler may not be required, since it is common to use one for transmit envelope tracking, predistortion, and/or other transmit closed loop tuning or control means.

A tunable filter (335) may normally be used in front of the ADC (340) or other baseband input circuitry, and may be implemented as a band pass filter or low pass filter, depending on the exact RF architecture: Low IF, Zero IF, or direct RF sampling of the RF carrier frequency. Part of the receive selectivity may normally be implemented in this filter, which may in turn mean that it may be adaptable to the various bandwidths that the system needs to support. In addition, the filter may need to be tuned to a bandwidth that is large enough to enable the features described above.

In one example, it is likely that 400 MHz or 800 MHz bandwidth may be supported in case the ADC and base band (340) used for the auxiliary linear receiver (310) are intended for FR2 bands. In such a case, the entire spectrum covering 3GPP frequency bands B7, B38, B40, and B41 as well as the 2.4 GHz ISM band may be monitored.

Wanted signal W (315) may not be detectable by the baseband. “UW” (345) refers to the unwanted strong signals that cause the strong IMD3 product. For the auxiliary receiver (310), the IMD3 product (350) may not be detectable, and only the two unwanted signals (345) may be detectable due to the high noise figure introduced with high coupling loss (30 dB in this example). Two tone intermodulation and IIP3 is illustrated with respect to FIG. 2, but this is not limiting; any number of tones may potentially cause similar problems, including but not limited to: One tone (IMD1), IMD 3 . . . IMDn. It is expected for practical systems that the 4th or 5th order may be the highest order of intermodulation products that can cause problems.

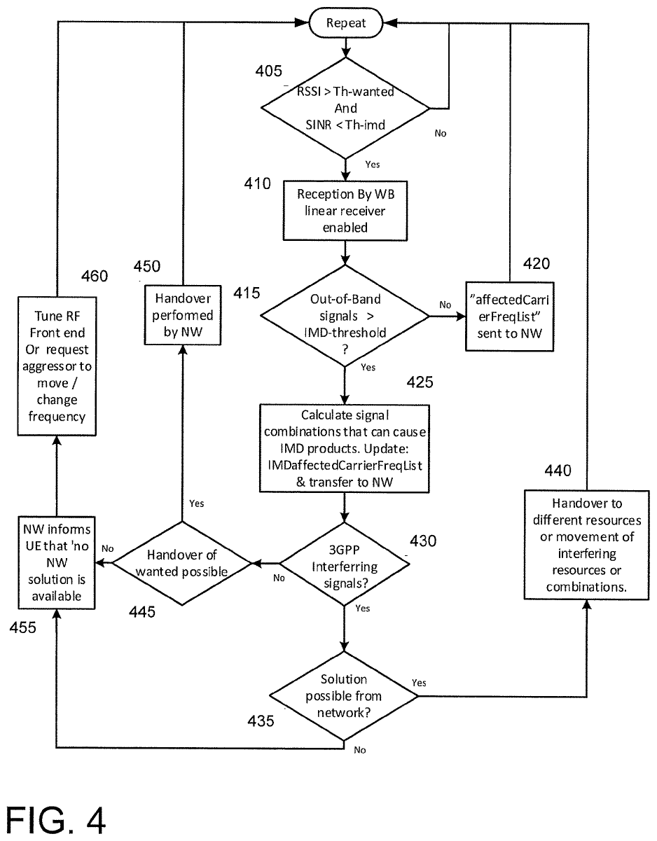

FIG. 4 illustrates a high-level flowchart illustrating example embodiment(s) of the present disclosure. At 405, it may be detected if it is likely that reception is affected by non-liner problems. It may be considered a clear indication that there might be a problem with linearity and potentially IMD problems if RSRP and/or RSSI is relatively high, but the signal quality RSRQ and/or signal to interference plus noise ratio (SINR) is poor/low. This evaluation may be based on thresholds internally defined in/by a UE, as it may be dependent on the UE's receiver implementation and its sensitivity to noise (e.g. a characteristic of the receiver). The threshold(s) for the received wanted signal is denoted as “Th-wanted.” The threshold(s) for the IMD level is denoted as “Th-imd.” It may be noted that the labels for these thresholds are not limiting.

At 410, a wideband linear receiver may be enabled and used in parallel with the normal receive process and used to detect and measure the spectrum also outside the used channel.

At 415, out-of-band signal levels may be detected, and it may be determined if they are strong enough to cause intermodulation problems. This may be performed based on an “IMD-threshold” parameter/value. If not, the source contributing to low SINR/RSRQ may be co-channel noise from the network or adjacent power from a transmitter nearby or an “in device” transmitter using ISM band. In other words, the interfering signals being below the IMD-threshold may indicate no or insignificant linearity problem, as the interfering signal levels are relatively low. The only solution may therefore be, at 420, to promote handover to different resources in the time and/or frequency domain. This may be performed by sending an “affectedCarrierFreqList” parameter [36.331, chapter 5.6.9.3] to the NW, which may or may not perform handover of the UE to different resources in time or frequency domain, or some other possible resolution, in response.

At 425, combinations of spectral components/signals may be calculated that may cause in-band interference. Based on these calculated combinations, an update may be applied to a newly defined parameter, IMDaffectedCarrierFreqList, which may contain a list of combinations of interfering signals and interfered frequencies (victim) that may cause intermodulation products resulting in poor co-channel performance. The IMDaffectedCarrierFreqList may be at least partially different from the affectedCarrierFreqList, for example because the IMDaffectedCarrierFreqList may be specifically configured to indicate resources that contribute to IMD issue(s). This means the IMD affected carrier may be different than the normal affected carrier and may require different mitigation. The IMDaffectedCarrierFreqList parameter may be transmitted to the NW. Messages such as the InDeviceCoexIndication message (which was introduced for E-UTRAN and may be introduced for NR (r18)) may be modified to include the IMDaffectedCarrierFreqList parameter.

An example of proposed format of the new parameter, IMDaffectedCarrierFreqList, is given below. It may be noted that the number of frequencies could be more than two, to cover higher order of intermodulation products.

IMDaffectedCarrierFreqList=Used_bandwidth (interfered carrier frequency1(victim), IMD11frequency, IMD21frequency) . . . (Interfered carrier frequencyN(victim), IMD1Nfrequency, IMD2Nfrequency)

Frequency resolution for reported frequencies=Used_bandwidth

The frequencies may be any part of the spectrum including ISM bands; the interfered frequency could also be ISM bands. The key is that moving any of: the desired, or any one of the interfering frequencies may have the technical effect of solving the IMD problem.

At 430, it may be determined, for example at the NW, if the aggressor spectral components that cause the in-band interference are, at least partially, inside the 3GPP licensed spectrum. If they are inside the 3GPP licensed spectrum, at 435, the network may evaluate if a possible solution can be provided considering both the aggressors and the wanted signal. In an example embodiment, several different possible solutions may be determined by the network in response to the IMDaffectedCarrierFreqList (e.g. moving one of the carriers and/or other possible responses/solutions). If a solution from the network is determined to be possible, at 440, the NW may be able to resolve the problem by, for example, triggering a switching of the active BWP of the UE to another intra-frequency BWP within the same cell, a reconfiguration of the BWP of the UE (e.g. UE may be directed to switch on BWP(s)), or an inter-frequency cell handover (e.g. move wanted signal by hand-over), or one of the aggressors may be moved by the network. The NW may initiate the movement of the aggressor or aggressor signal by itself, for example moving the aggressor or aggressor signal to another at least partially different carrier or frequency band. Alternatively, the NW may move the aggressor or aggressor signal per UE's request. Moving the aggressor may include removing the aggressor or aggressor signal from its operating carrier or frequency band. One example of the removal is switching off the aggressor or aggressor signal. In an example embodiment where carrier aggregation is used, to resolve the problem the NW may determine to trigger one or more of the following: the SCell of the UE may be deactivated, the BWP of the SCell may be changed, the SCell may be changed, and/or the SCell may be removed. The network may thus solve the problem. If a solution from the network is determined to not be possible, the network may inform the UE that no NW solution is available, at 455.

If the aggressor spectral components that cause the in-band interference are not inside the 3GPP licensed spectrum (i.e. not under network control), at 445 the network may evaluate whether to move the wanted signal by handover to solve the problem. The NW may inform the UE in, for example, a new RRCReconfiguration message that resolution is not possible by the network, at 455. In this case, the UE may tune its RF front end to resolve the problem, at 460. For example, the “problem” may be the result of IMD, such as noise, interference, and/or de-sense. RF front end tuning may be initiated to solve the problem, if the UE is capable of doing so, or the UE application processor may request that the aggressor be moved (e.g. move Wi-Fi channel).

At 450, if handover of the wanted signal is possible, handover may be triggered by the network.

Some or all the steps of FIG. 4 may be repeated as necessary.

The power levels defined above may be UE specific, and should not be interpreted as if the same absolute levels are the same for all UEs, as UE designs may perform better or a bit worse than implied above. This relates to Th-wanted, Th-imd and IMD-threshold(s). In an example embodiment, these parameters may be band and/or frequency dependent.

In an example embodiment, the UE may include a proposed HW change/configuration, which may have the technical effect of enabling the UE to detect unwanted frequencies, which may generate noise in the UE's receiver in the form of intermodulation product with other unwanted signals and/or the wanted received signal.

In an example embodiment, the UE may generate a list of problematic frequencies and provide this information to the network to enable the NW to resolve the problem by either removing the unwanted signal (if it is under 3GPP control) and/or shifting the frequency of the wanted signal (using intra-band or inter-band HO).

In an example embodiment, new signaling may be introduced for information exchange between the UE and the network node.

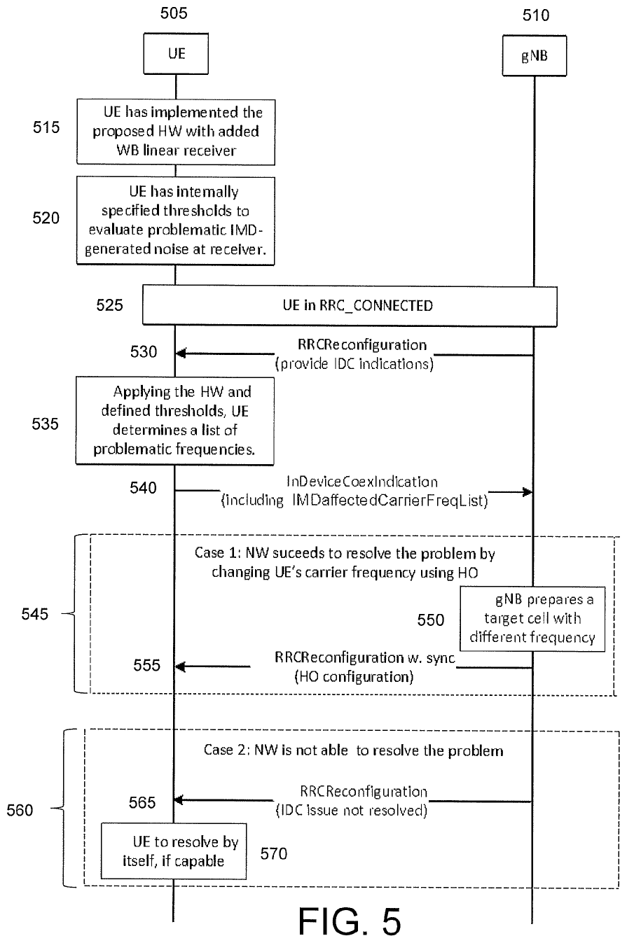

Referring now to FIG. 5, illustrated is an example of RRC communication according to example embodiments of the present disclosure. At 515, the UE (505) may have be configured with HW including but not limited to the added linear WB receiver in parallel to the ‘normal’ receiver (i.e. the receiver sufficient to receive the intended 3GPP bands)) described above, or may be programmed to perform processing to achieve the same result as the described parallel receivers. At 520, the UE (505) may have further defined thresholds for received signal, tolerable IMD, and/or other necessary threshold values. These thresholds may be used for evaluation of problematic IMD-generated noise at the receiver. In an example embodiment, the threshold values may be specific to the UE, and may depend on the UE's receiver implementation. In an example embodiment, the threshold values may be different based on the carrier frequency of the desired signal. In an example embodiment, the threshold may be changed dynamically based on the observed radio channel conditions by the UE.

At 525, the UE (505) may be in an RRC_CONNECTED state with respect to a network node (e.g. gNB) (510) and, at 530, may have received an RRC configuration; the network node may be configured to provide an IDC configuration. This configuration may be added to the 5G-NR RRC configuration in Rel-18.

At 535, the UE (505) may determine a list of problematic frequencies in terms of generated noise in the receive band due to IMD.

At 540, the RRC message InDeviceCoexIndication may be added (for example in 5G-NR) with a parameter, denoted IMDaffectedCarrierFreqList as an example. In an example embodiment, the UE may use this new message and parameter to inform the network node about the problematic frequencies. This parameter may be at least partially different from affectedCarrierFreqList. The IMDaffectedCarrierFreqList may enable the gNB to determine different solutions than the affectedCarrierFreqList.

Two alternative cases may be encountered, 545 and 560, illustrated in FIG. 5 with dotted lines. In the first case (545), the network (510) may be able to resolve the problem by, for example, selecting another cell with a different carrier frequency, may prepare a target cell with the different frequency (550), and may send the HO command to the UE (555), for example as part of an RRCReconfiguration message with synchronization. Additionally or alternatively, the problem may be resolved by switching the active BWP of the UE to another intra-frequency BWP within the same cell, reconfiguring the BWP of the UE, deactivating the SCell of the UE, changing the BWP of the SCell, changing the SCell, and/or removing the SCell. Additionally or alternatively, if the out-of-band aggressors are from 3GPP applications, the NW may be able to resolve the IDC issue by removing the aggressor (not shown in FIG. 5). In an example embodiment, the NW may choose a solution from several solutions available in light of the received IMDaffectedCarrierFreqList. One or a combination of solutions may be selected.

In the second case (560), the Network node (510) may not succeed in resolving the issue by removing the aggressor or finding a proper target cell for HO, and may inform the UE about not being able to resolve the issue (565). In an example embodiment, the NW may inform the UE in an RRCReconfiguration message with added new flag or a new introduced message for the purpose. In an example embodiment, some UEs may be able to resolve the issue (at least partially) on their own. If the UE has this capability, the UE may perform its own solution (e.g. RF tuning) (570), which may improve the performance but may not remove the issue completely.

A technical effect of example embodiments of the present disclosure may be that IMD3 products may be reduced by 20 dB where the IIP3 point is increased by 10 dB, as illustrated in FIG. 2. For practical two-tone intermodulation performance across a large dynamic range, the slope may vary, and may be higher or lower, as higher order intermodulation products may start to dominate and become stronger than the 3rd order intermodulation products. Different RF hardware embodiments that can be used to support the signaling and system aspects described above are described below. Many more different hardware embodiments can be used to support this, and the idea described here is not limited to the RF HW embodiments listed below.

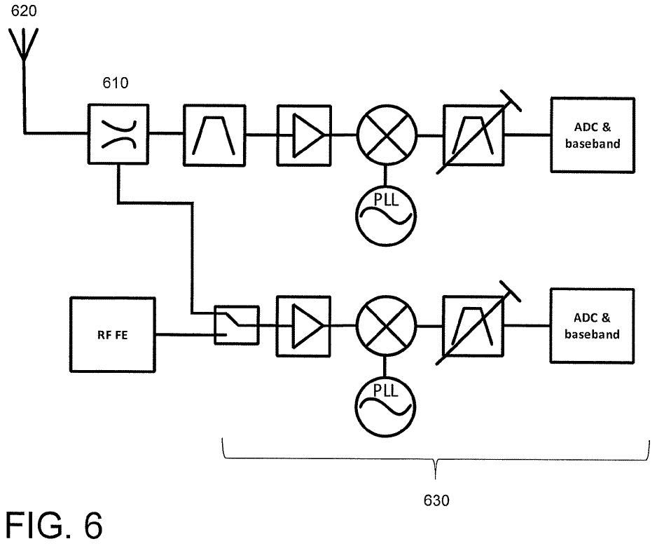

Referring now to FIG. 6, illustrated is a hardware embodiment that may be an alternative to FIG. 3. In the example of FIG. 6, the coupler (610) may be located directly at the antenna port (620). In an example embodiment, an auxiliary receive path (630) may be inherent in the system. In an example embodiment, the auxiliary receive path (630) may also be a 5 G mm wave path that naturally supports larger bandwidth and therefore may be well suited, as a larger bandwidth may be measured potentially covering several 3GPP bands at FR1.

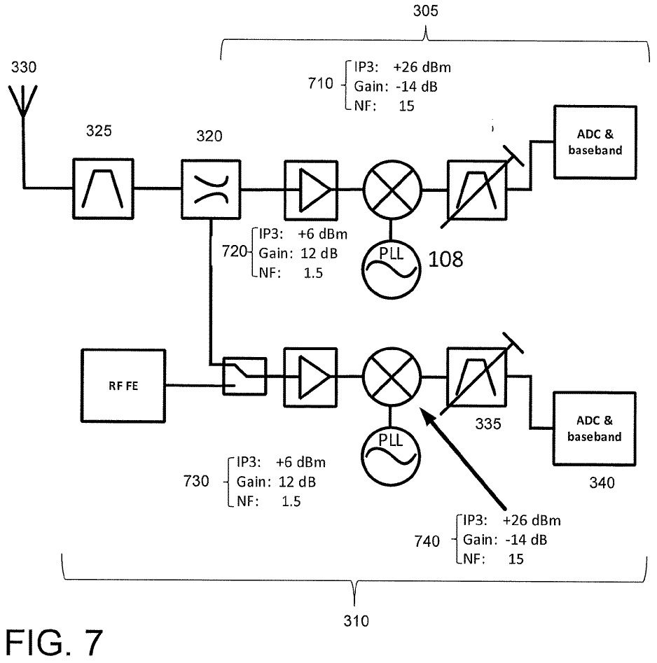

Referring now to FIG. 7, illustrated is a hardware embodiments similar to that of FIG. 6, with additional information included. For the sake of simplicity, overlapping features are not discussed again. Using the numbers as shown on FIG. 7 (710: IP3: +26 dBm, Gain: −14 dB, NF: 15; 720: IP3: +6 dBm, Gain: 12 dB, NF: 1.5; 730: IP3: +6 dBm, Gain: 12 dB, NF: 1.5; 740: IP3: +26 dBm, Gain: −14 dB, NF: 15), the cascaded IIP3 for the AUX path (310) may be calculated to be 35 dB dBm and NF=36 dB while the normal path (305) IIP3 may be calculated to be 5.4 dBm and NF=6.3.

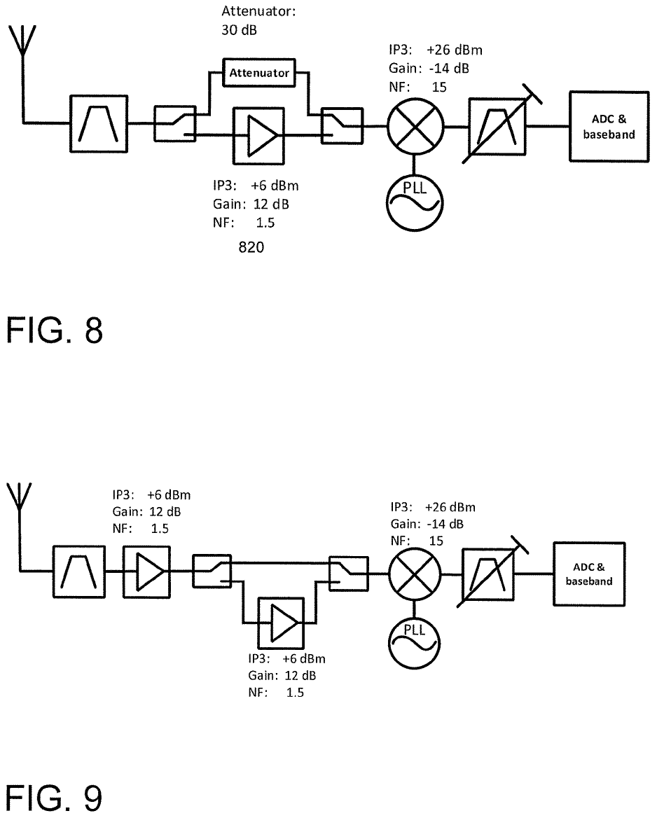

Referring now to FIG. 8, illustrated is an example of programmable linearity obtained by switching an attenuator (810) into the chain instead of the low noise amplifier (LNA) (820). With the LNA (820) turned on, the cascaded performance may become, for example: IIP3=6.3 dBm and the noise figure=6.3. For the LNA (820), the gain may be 12 dBm and the NF may be 1.5. If the attenuator (810) is switched in the cascaded performance may become, for example: IIP3=36 dBm and the noise figure=46 dB. A technical effect of this example embodiment may be that the desired and unwanted signal may only be measured sequentially, and not simultaneously. This solution may result in a relative high noise figure compared with some other solutions.

Referring now to FIG. 9, illustrated is another example of cascaded performance. In this example, the resulting cascaded performance for the RF FE may result in the NF changing from 2.3 dB to 7.3 dB and the IIP3 changing from −6.4 dBm to +5.4 dBm. The feedback receiver that is inherent in all RF front ends and normally used for various close loop control systems mainly for transmit circuitry may be used for the purposes described here.

A technical effect of example embodiments of the present disclosure may be that up to 3 or more solutions may be used to help mitigate the interference problems, rather than only one.

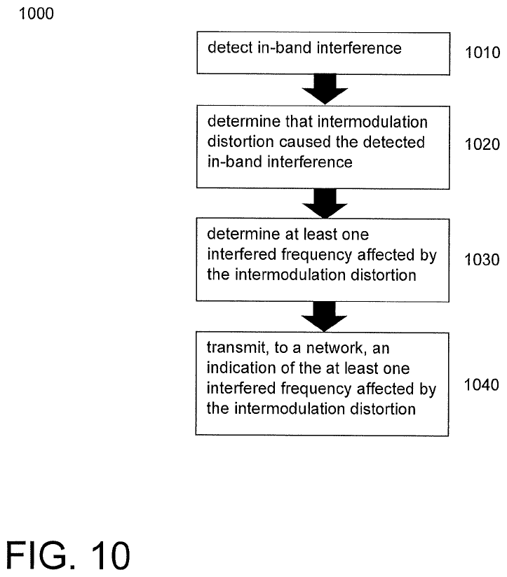

FIG. 10 illustrates the potential steps of an example method 1000. The example method 1000 may include: detecting in-band interference, 1010; determining that intermodulation distortion caused the detected in-band interference, 1020; determining at least one interfered frequency affected by the intermodulation distortion, 1030; and transmitting, to a network, an indication of the at least one interfered frequency affected by the intermodulation distortion, 1040. The example method 1000 may be performed, for example, with a user equipment.

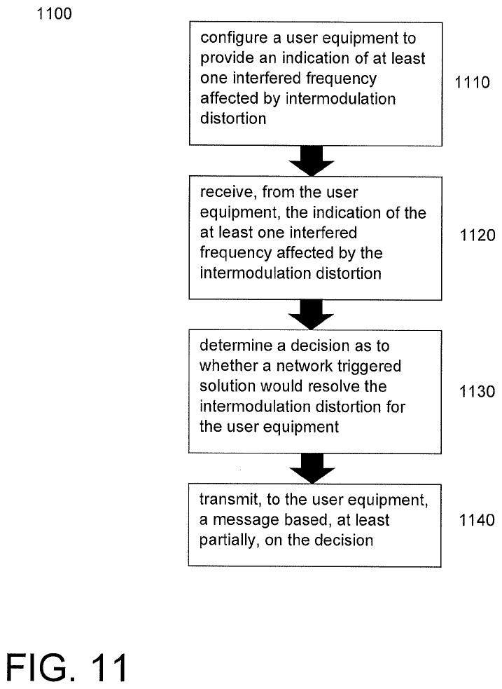

FIG. 11 illustrates the potential steps of an example method 1100. The example method 1100 may include: configuring a user equipment to provide an indication of at least one interfered frequency affected by intermodulation distortion, 1110; receiving, from the user equipment, the indication of the at least one interfered frequency affected by the intermodulation distortion, 1120; determining a decision as to whether a network triggered solution would resolve the intermodulation distortion for the user equipment, 1130; and transmitting, to the user equipment, a message based, at least partially, on the decision, 1140. The example method 1100 may be performed, for example, with a network node, such as a base station, eNB, and/or gNB.

In accordance with one example embodiment, an apparatus may comprise: at least one processor; and at least one memory storing instructions that, when executed by the at least one processor, cause the apparatus at least to: detect in-band interference; determine that intermodulation distortion caused the detected in-band interference; determine at least one interfered frequency affected by the intermodulation distortion; and transmit, to a network, an indication of the at least one interfered frequency affected by the intermodulation distortion.

Detecting the in-band interference may comprise the example apparatus being configured to: determine that at least one of a reference signal received power, or a received signal strength indicator is above a first threshold; and determine that at least one of reference signal received quality, or a signal to interference plus noise ratio is below a second threshold.

The example apparatus may be further configured to: determine at least one of the first threshold or the second threshold based on a characteristic of the apparatus.

Determining that the intermodulation distortion caused the detected in-band interference may comprise the example apparatus being further configured to: determine that a level of the intermodulation distortion is above a third threshold.

The indication of the at least one interfered frequency affected by the intermodulation distortion may be transmitted as part of an in-device coexistence indication message.

The indication of the at least one interfered frequency affected by the intermodulation distortion may comprise an intermodulation distortion-affected carrier frequency list parameter.

The example apparatus may be further configured to: determine at least one combination of signals that cause the intermodulation distortion, wherein the at least one combination of signals may comprise at least one of: at least one wanted signal, or at least one aggressor signal; and transmit, to the network, an indication of the at least one combination of signals.

At least one of the at least one wanted signal or the at least one aggressor signal may comprise at least a part of an industrial, scientific and medical band.

The example apparatus may be further configured to: receive, from the network, a message, wherein the message may comprise one of: an indication that an in-device coexistence issue is not resolved at the network, an indication to switch an active bandwidth part, a reconfiguration for the active bandwidth part, a reconfiguration for a serving cell, or a handover configuration.

The message may comprise a radio resource control reconfiguration message.

The example apparatus may be further configured to, in response to receiving the message comprising the indication that the coexistence issue is not resolved at the network, perform radio frequency front end tuning.

The detected in-band interference may further comprise at least one of: in-band noise, or noise that is a result of an intermodulation product from at least one out-of-band interferer.

In accordance with one aspect, an example method may be provided comprising: detecting, with a user equipment, in-band interference; determining that intermodulation distortion caused the detected in-band interference; determining at least one interfered frequency affected by the intermodulation distortion; and transmitting, to a network, an indication of the at least one interfered frequency affected by the intermodulation distortion.

The detecting of the in-band interference may comprise: determining that at least one of a reference signal received power, or a received signal strength indicator is above a first threshold; and determining that at least one of reference signal received quality, or a signal to interference plus noise ratio is below a second threshold.

The example method may further comprise: determining at least one of the first threshold or the second threshold based on a characteristic of the user equipment.

The determining that the intermodulation distortion caused the detected in-band interference may comprise: determining that a level of the intermodulation distortion is above a third threshold.

The indication of the at least one interfered frequency affected by the intermodulation distortion may be transmitted as part of an in-device coexistence indication message.

The indication of the at least one interfered frequency affected by the intermodulation distortion may comprise an intermodulation distortion-affected carrier frequency list parameter.

The example method may further comprise: determining at least one combination of signals that cause the intermodulation distortion, wherein the at least one combination of signals may comprise at least one of: at least one wanted signal, or at least one aggressor signal; and transmitting, to the network, an indication of the at least one combination of signals.

At least one of the at least one wanted signal or the at least one aggressor signal may comprise at least a part of an industrial, scientific and medical band.

The example method may further comprise: receiving, from the network, a message, wherein the message may comprise one of: an indication that an in-device coexistence issue is not resolved at the network, an indication to switch an active bandwidth part, a reconfiguration for the active bandwidth part, a reconfiguration for a serving cell, or a handover configuration.

The message may comprise a radio resource control reconfiguration message.

The example method may further comprise, in response to receiving the message comprising the indication that the coexistence issue is not resolved at the network, performing radio frequency front end tuning.

The detected in-band interference may further comprise at least one of: in-band noise, or noise that is a result of an intermodulation product from at least one out-of-band interferer.

In accordance with one example embodiment, an apparatus may comprise: circuitry configured to perform: detecting, with a user equipment, in-band interference; circuitry configured to perform: determining that intermodulation distortion caused the detected in-band interference; circuitry configured to perform: determining at least one interfered frequency affected by the intermodulation distortion; and circuitry configured to perform: transmitting, to a network, an indication of the at least one interfered frequency affected by the intermodulation distortion.

In accordance with one example embodiment, an apparatus may comprise: processing circuitry; memory circuitry including computer program code, the memory circuitry and the computer program code configured to, with the processing circuitry, enable the apparatus to: detect in-band interference; determine that intermodulation distortion caused the detected in-band interference; determine at least one interfered frequency affected by the intermodulation distortion; and transmit, to a network, an indication of the at least one interfered frequency affected by the intermodulation distortion.

As used in this application, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

In accordance with one example embodiment, an apparatus may comprise means for performing: detecting in-band interference; determining that intermodulation distortion caused the detected in-band interference; determining at least one interfered frequency affected by the intermodulation distortion; and transmitting, to a network, an indication of the at least one interfered frequency affected by the intermodulation distortion.

The means configured to perform detecting the in-band interference may comprise means configured to perform: determining that at least one of a reference signal received power, or a received signal strength indicator is above a first threshold; and determining that at least one of reference signal received quality, or a signal to interference plus noise ratio is below a second threshold.

The means may be further configured to perform: determining at least one of the first threshold or the second threshold based on a characteristic of the apparatus.

The means configured to perform determining that the intermodulation distortion cause the detected in-band interference may comprise means configured to perform: determining that a level of the intermodulation distortion is above a third threshold.

The indication of the at least one interfered frequency affected by the intermodulation distortion may be transmitted as part of an in-device coexistence indication message.

The indication of the at least one interfered frequency affected by the intermodulation distortion may comprise an intermodulation distortion-affected carrier frequency list parameter.

The means may be further configured to perform: determining at least one combination of signals that cause the intermodulation distortion, wherein the at least one combination of signals may comprise at least one of: at least one wanted signal, or at least one aggressor signal; and transmitting, to the network, an indication of the at least one combination of signals.

At least one of the at least one wanted signal or the at least one aggressor signal may comprise at least a part of an industrial, scientific and medical band.

The means may be further configured to perform: receiving, from the network, a message, wherein the message may comprise one of: an indication that an in-device coexistence issue is not resolved at the network, an indication to switch an active bandwidth part, a reconfiguration for the active bandwidth part, a reconfiguration for a serving cell, or a handover configuration.

The message may comprise a radio resource control reconfiguration message.

The means may be further configured to perform, in response to receiving the message comprising the indication that the coexistence issue is not resolved at the network, radio frequency front end tuning.

The detected in-band interference may further comprise at least one of: in-band noise, or noise that is a result of an intermodulation product from at least one out-of-band interferer.

A processor, memory, and/or example algorithms (which may be encoded as instructions, program, or code) may be provided as example means for providing or causing performance of operation.

In accordance with one example embodiment, a non-transitory computer-readable medium comprising instructions stored thereon which, when executed with at least one processor, cause the at least one processor to: cause detecting of in-band interference; determine that intermodulation distortion caused the detected in-band interference; determine at least one interfered frequency affected by the intermodulation distortion; and cause transmitting, to a network, of an indication of the at least one interfered frequency affected by the intermodulation distortion.

In accordance with another example embodiment, a non-transitory program storage device readable by a machine may be provided, tangibly embodying instructions executable by the machine for performing operations, the operations comprising: detecting in-band interference; determining that intermodulation distortion caused the detected in-band interference; determining at least one interfered frequency affected by the intermodulation distortion; and transmitting, to a network, an indication of the at least one interfered frequency affected by the intermodulation distortion.

In accordance with another example embodiment, a non-transitory computer-readable medium comprising program instructions stored thereon for performing at least the following: causing detecting of in-band interference; determining that intermodulation distortion caused the detected in-band interference; determining at least one interfered frequency affected by the intermodulation distortion; and causing transmitting, to a network, of an indication of the at least one interfered frequency affected by the intermodulation distortion.

In accordance with another example embodiment, a non-transitory computer-readable medium comprising instructions that, when executed by an apparatus, cause the apparatus to perform at least the following: detecting in-band interference; determining that intermodulation distortion caused the detected in-band interference; determining at least one interfered frequency affected by the intermodulation distortion; and transmitting, to a network, an indication of the at least one interfered frequency affected by the intermodulation distortion.

A computer implemented system comprising: at least one processor and at least one non-transitory memory storing instructions that, when executed by the at least one processor, cause the system at least to perform: detecting in-band interference; determining that intermodulation distortion caused the detected in-band interference; determining at least one interfered frequency affected by the intermodulation distortion; and transmitting, to a network, an indication of the at least one interfered frequency affected by the intermodulation distortion.

A computer implemented system comprising: means for detecting in-band interference; means for determining that intermodulation distortion caused the detected in-band interference; means for determining at least one interfered frequency affected by the intermodulation distortion; and means for transmitting, to a network, an indication of the at least one interfered frequency affected by the intermodulation distortion.

In accordance with one example embodiment, an apparatus may comprise: at least one processor; and at least one memory storing instructions that, when executed by the at least one processor, cause the apparatus at least to: configure a user equipment to provide an indication of at least one interfered frequency affected by intermodulation distortion; receive, from the user equipment, the indication of the at least one interfered frequency affected by the intermodulation distortion; determine a decision as to whether a network triggered solution would resolve the intermodulation distortion for the user equipment; and transmit, to the user equipment, a message based, at least partially, on the decision.

The message may comprise at least one of: an indication that an in-device coexistence issue is not resolved with the network triggered solution, an indication to switch an active bandwidth part of the user equipment, a reconfiguration for the active bandwidth part of the user equipment, a reconfiguration for a serving cell of the user equipment, or a handover configuration for the user equipment.

The example apparatus may be further configured to: perform handover of the user equipment from a source serving cell to a target cell.

The example apparatus may be further configured to: receive, from the user equipment, an indication of at least one combination of signals that caused the intermodulation distortion, wherein the at least one combination of signals may comprise at least one of: at least one wanted signal, or at least one aggressor signal.

The example apparatus may be further configured to: determine that the at least one aggressor signal may be within a licensed spectrum.

The example apparatus may be further configured to: determine that the network triggered solution would resolve the intermodulation distortion for the user equipment, wherein the network triggered solution may comprise at least one of: handover of the user equipment to another cell, switching of an active bandwidth part of the user equipment, reconfiguration of the active bandwidth part of the user equipment, reconfiguration of a serving cell of the user equipment, or moving at least one aggressor.

The example apparatus may be further configured to: trigger the at least one of: the handover of the user equipment to the another cell, the switching of the active bandwidth part of the user equipment, the reconfiguration of the active bandwidth part of the user equipment, the reconfiguration of the serving cell of the user equipment, or the moving of the at least one aggressor.

The example apparatus may be further configured to: determine that the at least one aggressor signal is outside a licensed spectrum.

The example apparatus may be further configured to: determine that the network triggered solution would resolve the intermodulation distortion for the user equipment, wherein the network triggered solution may comprise at least one of: handover of the user equipment to another cell, switching of an active bandwidth part of the user equipment, reconfiguration of the active bandwidth part of the user equipment, or reconfiguration of a serving cell of the user equipment.

The example apparatus may be further configured to: trigger the at least one of: the handover of the user equipment to the another cell, the switching of the active bandwidth part of the user equipment, the reconfiguration of the active bandwidth part of the user equipment, or the reconfiguration of the serving cell of the user equipment.

The example apparatus may be further configured to: determine that a network triggered solution would not resolve the intermodulation distortion for the user equipment, wherein the message may comprise an indication that an in-device coexistence issue is not resolved for the user equipment.

The message may comprise a radio resource control reconfiguration message.

In accordance with one aspect, an example method may be provided comprising: configuring, with a network, a user equipment to provide an indication of at least one interfered frequency affected by intermodulation distortion; receiving, from the user equipment, the indication of the at least one interfered frequency affected by the intermodulation distortion; determining a decision as to whether a network triggered solution would resolve the intermodulation distortion for the user equipment; and transmitting, to the user equipment, a message based, at least partially, on the decision.

The message may comprise at least one of: an indication that an in-device coexistence issue is not resolved with the network triggered solution, an indication to switch an active bandwidth part of the user equipment, a reconfiguration for the active bandwidth part of the user equipment, a reconfiguration for a serving cell of the user equipment, or a handover configuration for the user equipment.

The example method may further comprise: performing handover of the user equipment from a source serving cell to a target cell.

The example method may further comprise: receiving, from the user equipment, an indication of at least one combination of signals that caused the intermodulation distortion, wherein the at least one combination of signals may comprise at least one of: at least one wanted signal, or at least one aggressor signal.

The example method may further comprise: determining that the at least one aggressor signal may be within a licensed spectrum.

The example method may further comprise: determining that the network triggered solution would resolve the intermodulation distortion for the user equipment, wherein the network triggered solution may comprise at least one of: handover of the user equipment to another cell, switching of an active bandwidth part of the user equipment, reconfiguration of the active bandwidth part of the user equipment, reconfiguration of a serving cell of the user equipment, or moving at least one aggressor.

The example method may further comprise: triggering the at least one of: the handover of the user equipment to the another cell, the switching of the active bandwidth part of the user equipment, the reconfiguration of the active bandwidth part of the user equipment, the reconfiguration of the serving cell of the user equipment, or the moving of the at least one aggressor.

The example method may further comprise: determining that the at least one aggressor signal may be outside a licensed spectrum.

The example method may further comprise: determining that the network triggered solution would resolve the intermodulation distortion for the user equipment, wherein the network triggered solution may comprise at least one of: handover of the user equipment to another cell, switching of an active bandwidth part of the user equipment, reconfiguration of the active bandwidth part of the user equipment, or reconfiguration of a serving cell of the user equipment.

The example method may further comprise: triggering the at least one of: the handover of the user equipment to the another cell, the switching of the active bandwidth part of the user equipment, the reconfiguration of the active bandwidth part of the user equipment, or the reconfiguration of the serving cell of the user equipment.

The example method may further comprise: determining that a network triggered solution would not resolve the intermodulation distortion for the user equipment, wherein the message may comprise an indication that an in-device coexistence issue is not resolved for the user equipment.

The message may comprise a radio resource control reconfiguration message.

In accordance with one example embodiment, an apparatus may comprise: circuitry configured to perform: configuring, with a network, a user equipment to provide an indication of at least one interfered frequency affected by intermodulation distortion; circuitry configured to perform: receiving, from the user equipment, the indication of the at least one interfered frequency affected by the intermodulation distortion; circuitry configured to perform: determining a decision as to whether a network triggered solution would resolve the intermodulation distortion for the user equipment; and circuitry configured to perform: transmitting, to the user equipment, a message based, at least partially, on the decision.

In accordance with one example embodiment, an apparatus may comprise: processing circuitry; memory circuitry including computer program code, the memory circuitry and the computer program code configured to, with the processing circuitry, enable the apparatus to: configure a user equipment to provide an indication of at least one interfered frequency affected by intermodulation distortion; receive, from the user equipment, the indication of the at least one interfered frequency affected by the intermodulation distortion; determine a decision as to whether a network triggered solution would resolve the intermodulation distortion for the user equipment; and transmit, to the user equipment, a message based, at least partially, on the decision.

In accordance with one example embodiment, an apparatus may comprise means for performing: configuring a user equipment to provide an indication of at least one interfered frequency affected by intermodulation distortion; receiving, from the user equipment, the indication of the at least one interfered frequency affected by the intermodulation distortion; determining a decision as to whether a network triggered solution would resolve the intermodulation distortion for the user equipment; and transmitting, to the user equipment, a message based, at least partially, on the decision.

The message may comprise at least one of: an indication that an in-device coexistence issue is not resolved with the network triggered solution, an indication to switch an active bandwidth part of the user equipment, a reconfiguration for the active bandwidth part of the user equipment, a reconfiguration for a serving cell of the user equipment, or a handover configuration for the user equipment.

The means may be further configured to perform: handover of the user equipment from a source serving cell to a target cell.

The means may be further configured to perform: receiving, from the user equipment, an indication of at least one combination of signals that cause the intermodulation distortion, wherein the at least one combination of signals may comprise at least one of: at least one wanted signal, or at least one aggressor signal.

The means may be further configured to perform: determining that the at least one aggressor signal may be within a licensed spectrum.

The means may be further configured to perform: determining that the network triggered solution would resolve the intermodulation distortion for the user equipment, wherein the network triggered solution may comprise at least one of: handover of the user equipment to another cell, switching of an active bandwidth part of the user equipment, reconfiguration of the active bandwidth part of the user equipment, reconfiguration of a serving cell of the user equipment, or moving at least one aggressor.

The means may be further configured to perform trigger of the at least one of: the handover of the user equipment to the another cell, the switching of the active bandwidth part of the user equipment, the reconfiguration of the active bandwidth part of the user equipment, the reconfiguration of the serving cell of the user equipment, or the moving of the at least one aggressor.

The means may be further configured to perform: determining that the at least one aggressor signal may be outside a licensed spectrum.

The means may be further configured to perform: determining that the network triggered solution would resolve the intermodulation distortion for the user equipment, wherein the network triggered solution may comprise at least one of: handover of the user equipment to another cell, switching of an active bandwidth part of the user equipment, reconfiguration of the active bandwidth part of the user equipment, or reconfiguration of a serving cell of the user equipment.

The means may be further configured to perform triggering of the at least one of: the handover of the user equipment to the another cell, the switching of the active bandwidth part of the user equipment, the reconfiguration of the active bandwidth part of the user equipment, or the reconfiguration of the serving cell of the user equipment.

The means may be further configured to perform: determining that a network triggered solution would not resolve the intermodulation distortion for the user equipment, wherein the message may comprise an indication that an in-device coexistence issue is not resolved for the user equipment.

The message may comprise a radio resource control reconfiguration message.

In accordance with one example embodiment, a non-transitory computer-readable medium comprising instructions stored thereon which, when executed with at least one processor, cause the at least one processor to: cause configuration of a user equipment to provide an indication of at least one interfered frequency affected by intermodulation distortion; cause receiving, from the user equipment, of the indication of the at least one interfered frequency affected by the intermodulation distortion; determine a decision as to whether a network triggered solution would resolve the intermodulation distortion for the user equipment; and cause transmitting, to the user equipment, of a message based, at least partially, on the decision.

In accordance with another example embodiment, a non-transitory program storage device readable by a machine may be provided, tangibly embodying instructions executable by the machine for performing operations, the operations comprising: configuring a user equipment to provide an indication of at least one interfered frequency affected by intermodulation distortion; receiving, from the user equipment, the indication of the at least one interfered frequency affected by the intermodulation distortion; determining a decision as to whether a network triggered solution would resolve the intermodulation distortion for the user equipment; and transmitting, to the user equipment, a message based, at least partially, on the decision.

In accordance with another example embodiment, a non-transitory computer-readable medium comprising instructions that, when executed by an apparatus, cause the apparatus to perform at least the following: configuring a user equipment to provide an indication of at least one interfered frequency affected by intermodulation distortion; receiving, from the user equipment, the indication of the at least one interfered frequency affected by the intermodulation distortion; determining a decision as to whether a network triggered solution would resolve the intermodulation distortion for the user equipment; and transmitting, to the user equipment, a message based, at least partially, on the decision.

In accordance with another example embodiment, a non-transitory computer-readable medium comprising program instructions stored thereon for performing at least the following: causing configuration of a user equipment to provide an indication of at least one interfered frequency affected by intermodulation distortion; causing receiving, from the user equipment, of the indication of the at least one interfered frequency affected by the intermodulation distortion; determining a decision as to whether a network triggered solution would resolve the intermodulation distortion for the user equipment; and causing transmitting, to the user equipment, of a message based, at least partially, on the decision.

A computer implemented system comprising: at least one processor and at least one non-transitory memory storing instructions that, when executed by the at least one processor, cause the system at least to perform: configuring a user equipment to provide an indication of at least one interfered frequency affected by intermodulation distortion; receiving, from the user equipment, the indication of the at least one interfered frequency affected by the intermodulation distortion; determining a decision as to whether a network triggered solution would resolve the intermodulation distortion for the user equipment; and transmitting, to the user equipment, a message based, at least partially, on the decision.

A computer implemented system comprising: means for configuring a user equipment to provide an indication of at least one interfered frequency affected by intermodulation distortion; means for receiving, from the user equipment, the indication of the at least one interfered frequency affected by the intermodulation distortion; means for determining a decision as to whether a network triggered solution would resolve the intermodulation distortion for the user equipment; and means for transmitting, to the user equipment, a message based, at least partially, on the decision.

The term “non-transitory,” as used herein, is a limitation of the medium itself (i.e. tangible, not a signal) as opposed to a limitation on data storage persistency (e.g., RAM vs. ROM).

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modification and variances which fall within the scope of the appended claims.

1-50. (canceled)

51. An apparatus comprising:
at least one processor; and
at least one memory storing instructions that, when executed by the at least one processor, cause the apparatus at least to:
detect in-band interference;
determine that intermodulation distortion caused the detected in-band interference;
determine at least one interfered frequency affected by the intermodulation distortion; and
transmit, to a network, an indication of the at least one interfered frequency affected by the intermodulation distortion.

52. The apparatus of claim 51, wherein detecting the in-band interference comprises the at least one memory, storing the instructions, when executed by the at least one processor, causes the apparatus to:
determine that at least one of a reference signal received power, or a received signal strength indicator is above a first threshold; and
determine that at least one of reference signal received quality, or a signal to interference plus noise ratio is below a second threshold.

53. The apparatus of claim 52, wherein the at least one memory, storing the instructions, when executed by the at least one processor, causes the apparatus to:
determine at least one of the first threshold or the second threshold based on a characteristic of the apparatus.

54. The apparatus of claim 51, wherein determining that the intermodulation distortion caused the detected in-band interference comprises the at least one memory, storing the instructions, when executed by the at least one processor, causes the apparatus to:
determine that a level of the intermodulation distortion is above a third threshold.

55. The apparatus of claim 51, wherein the indication of the at least one interfered frequency affected by the intermodulation distortion is transmitted as part of an in-device coexistence indication message.

56. The apparatus of claim 51, wherein the indication of the at least one interfered frequency affected by the intermodulation distortion comprises an intermodulation distortion-affected carrier frequency list parameter.

57. The apparatus of claim 51, wherein the at least one memory, storing the instructions, when executed by the at least one processor, causes the apparatus to:
determine at least one combination of signals that caused the intermodulation distortion, wherein the at least one combination of signals comprises at least one of:
at least one wanted signal, or
at least one aggressor signal; and
transmit, to the network, an indication of the at least one combination of signals.

58. The apparatus of claim 57, wherein at least one of the at least one wanted signal or the at least one aggressor signal comprises at least a part of an industrial, scientific and medical band.

59. The apparatus of claim 51, wherein the at least one memory, storing the instructions, when executed by the at least one processor, causes the apparatus to:
receive, from the network, a message, wherein the message comprises one of:
an indication that an in-device coexistence issue is not resolved at the network,
an indication to switch an active bandwidth part,
a reconfiguration for the active bandwidth part,
a reconfiguration for a serving cell, or
a handover configuration.

60. The apparatus of claim 59, wherein the message comprises a radio resource control reconfiguration message.

61. A method comprising:
detecting, with a user equipment, in-band interference;
determining that intermodulation distortion caused the detected in-band interference;
determining at least one interfered frequency affected by the intermodulation distortion; and
transmitting, to a network, an indication of the at least one interfered frequency affected by the intermodulation distortion.

62. An apparatus comprising:
at least one processor; and
at least one memory storing instructions that, when executed by the at least one processor, cause the apparatus at least to:
configure a user equipment to provide an indication of at least one interfered frequency affected by intermodulation distortion;
receive, from the user equipment, the indication of the at least one interfered frequency affected by the intermodulation distortion;
determine a decision as to whether a network triggered solution would resolve the intermodulation distortion for the user equipment; and
transmit, to the user equipment, a message based, at least partially, on the decision.

63. The apparatus of claim 62, wherein the message comprises at least one of:
an indication that an in-device coexistence issue is not resolved with the network triggered solution,
an indication to switch an active bandwidth part of the user equipment,
a reconfiguration for the active bandwidth part of the user equipment,
a reconfiguration for a serving cell of the user equipment, or
a handover configuration for the user equipment.

64. The apparatus of claim 62, wherein the at least one memory, storing the instructions, when executed by the at least one processor, causes the apparatus to:
receive, from the user equipment, an indication of at least one combination of signals that caused the intermodulation distortion, wherein the at least one combination of signals comprises at least one of:
at least one wanted signal, or
at least one aggressor signal.

65. The apparatus of claim 64, wherein the at least one memory, storing the instructions, when executed by the at least one processor, causes the apparatus to:
determine that the at least one aggressor signal is within a licensed spectrum.

66. The apparatus of claim 62, wherein the at least one memory, storing the instructions, when executed by the at least one processor, causes the apparatus to:
determine that the network triggered solution would resolve the intermodulation distortion for the user equipment, wherein the network triggered solution comprises at least one of:
handover of the user equipment to another cell,
switching of an active bandwidth part of the user equipment,
reconfiguration of the active bandwidth part of the user equipment,
reconfiguration of a serving cell of the user equipment, or
moving at least one aggressor signal.

67. The apparatus of claim 66, wherein the at least one memory, storing the instructions, when executed by the at least one processor, causes the apparatus to trigger the at least one of:
the handover of the user equipment to the another cell,
the switching of the active bandwidth part of the user equipment,
the reconfiguration of the active bandwidth part of the user equipment,
the reconfiguration of the serving cell of the user equipment, or
the moving of the at least one aggressor signal.

68. The apparatus of claim 64, wherein the at least one memory, storing the instructions, when executed by the at least one processor, causes the apparatus to:
determine that the at least one aggressor signal is outside a licensed spectrum.

69. The apparatus of claim 68, wherein the at least one memory, storing the instructions, when executed by the at least one processor, causes the apparatus to:
determine that the network triggered solution would resolve the intermodulation distortion for the user equipment, wherein the network triggered solution comprises at least one of:
handover of the user equipment to another cell,
switching of an active bandwidth part of the user equipment,
reconfiguration of the active bandwidth part of the user equipment, or
reconfiguration of a serving cell of the user equipment.

70. The apparatus of claim 69, wherein the at least one memory, storing the instructions, when executed by the at least one processor, causes the apparatus to trigger the at least one of:
the handover of the user equipment to the another cell,
the switching of the active bandwidth part of the user equipment,
the reconfiguration of the active bandwidth part of the user equipment, or
the reconfiguration of the serving cell of the user equipment.
